(19) United States
(12) Patent Application Publication
(10) Pub. No.: US 2023/0185114 A1
(43) Pub. Date: Jun. 15, 2023

(54) EYEWEAR

(71) Applicant: Shanghai Tianma Micro-Electronics Co., Ltd., Shanghai (CN)

(72) Inventors: Quanpeng YU, Shanghai (CN); Qijun YAO, Shanghai (CN); Yang ZENG, Shanghai (CN); Ran HUANG, Shanghai (CN)

(73) Assignee: Shanghai Tianma Micro-Electronics Co., Ltd., Shanghai (CN)

(21) Appl. No.: 18/164,450

(22) Filed: Feb. 3, 2023

(30) Foreign Application Priority Data
Nov. 3, 2022 (CN) 202211368696.4

(51) Int. Cl. G02C 11/00; G02B 27/01; F21V 8/00

(52) U.S. Cl. CPC G02C 11/10; G02B 27/0172; G02B 6/0036; G02C 2202/24; G02B 2027/0178

(57) ABSTRACT

An eyewear is provided. The eyewear includes a display functional layer and a light-guiding structure. The light-guiding structure is located at a side of the display functional layer facing towards a viewing surface, or the display functional layer surrounds the light-guiding structure.

### CROSS-REFERENCE TO RELATED APPLICATIONS

The present application claims priority to Chinese Patent Application No. 202211368696.4, filed on Nov. 3, 2022, the content of which is incorporated herein by reference in its entirety.

### TECHNICAL FIELD

The present disclosure relates to the field of vision correction technologies, and in particular, to an eyewear.

### BACKGROUND

For human eye vision, defocus indicates that the focal point of the image is not on the retina when viewing an object, that is, the focal point is out of the retina. If the focal point falls behind the retina, the hyperopic defocus is formed. If the focal point falls in front of the retina, the myopic defocus is formed. For myopia, a peripheral hyperopic defocus is formed after wearing normal lenses to correct the vision. In the peripheral hyperopic defocus region, the retina grows towards the image in order to see the image clearly, thus causing increase of the axis length of eye, thereby increasing the myopic diopter.

### SUMMARY

Embodiments of the present disclosure provide an eyewear. The eyewear includes a display functional layer and a light-guiding structure. The light-guiding structure is located at a side of the display functional layer facing towards a viewing surface, or the display functional layer surrounds the light-guiding structure.

### BRIEF DESCRIPTION OF DRAWINGS

In order to more clearly illustrate the embodiments of the present disclosure, the accompanying drawings used in the embodiments are briefly described below. The drawings described below are merely a part of the embodiments of the present disclosure. The accompanying drawings in the following description are some embodiments of the present disclosure, and other accompanying drawings can be obtained in accordance with these drawings for those skilled in the art.

FIG. 1 is a schematic diagram of myopia imaging;

FIG. 2 is a schematic diagram of imaging after correcting vision by a normal myopic lens;

FIG. 3 is a partial schematic diagram of an eyewear provided by some embodiments of the present disclosure;

FIG. 4 is a cross-sectional view along line A-A′ shown in FIG. 3;

FIG. 5 is a schematic diagram of an imaging principle of an eyewear provided by some embodiments of the present disclosure;

FIG. 6 is a schematic diagram of another imaging principle of an eyewear provided by some embodiments of the present disclosure;

FIG. 7 is another cross-sectional view along line A-A′ shown in FIG. 3;

FIG. 8 is another cross-sectional view along line A-A′ shown in FIG. 3;

FIG. 9 is a simplified schematic diagram of an optical path of an eyewear provided by embodiments of FIG. 7;

FIG. 10 is a schematic diagram of a myopia correction of an eyewear provided by some embodiments of the present disclosure;

FIG. 11 is another cross-sectional view along line A-A′ shown in FIG. 3;

FIG. 12 is another cross-sectional view along line A-A′ shown in FIG. 3;

FIG. 13 is another cross-sectional view along line A-A′ shown in FIG. 3;

FIG. 14 is another cross-sectional view along line A-A′ shown in FIG. 3;

FIG. 15 is another cross-sectional view along line A-A′ shown in FIG. 3;

FIG. 16 is another cross-sectional view along line A-A′ shown in FIG. 3;

FIG. 17 is another cross-sectional view along line A-A′ shown in FIG. 3;

FIG. 18 is a schematic diagram of another eyewear provided by some embodiments of the present disclosure;

FIG. 19 is a schematic diagram of another eyewear provided by some embodiments of the present disclosure;

FIG. 20 is a schematic diagram of another eyewear provided by some embodiments of the present disclosure;

FIG. 21 is a curve representing a relationship between a layer distance and a lens focal length obtained from a simulation test;

FIG. 22 is another cross-sectional view along line A-A′ shown in FIG. 3;

FIG. 23 is a schematic diagram of a functional pattern provided by some embodiments of the present disclosure;

FIG. 24 is a schematic diagram of another functional pattern provided by some embodiments of the present disclosure;

FIG. 25 is a schematic diagram of a pixel sub-region in an eyewear provided by some embodiments of the present disclosure;

FIG. 26 is a schematic diagram of another pixel sub-region in an eyewear provided by some embodiments of the present disclosure;

FIG. 27 is a schematic diagram of another functional pattern provided by some embodiments of the present disclosure;

FIG. 28 is a schematic diagram of another functional pattern provided by some embodiments of the present disclosure;

FIG. 29 is a schematic diagram of another functional pattern provided by some embodiments of the present disclosure;

FIG. 30 is a schematic diagram of another eyewear provided by some embodiments of the present disclosure;

FIG. 31 is a schematic diagram of another eyewear provided by some embodiments of the present disclosure;

FIG. 32 is a schematic diagram of another eyewear provided by some embodiments of the present disclosure;

FIG. 33 is another cross-sectional view along line A-A′ shown in FIG. 3;

FIG. 34 is a schematic diagram of another eyewear provided by some embodiments of the present disclosure;

FIG. 35 is another cross-sectional view along line B-B′ shown in FIG. 34;

FIG. 36 is an enlarged schematic view of a region Q1 shown in FIG. 34;

FIG. 37 is a schematic diagram of another eyewear provided by some embodiments of the present disclosure;

FIG. 38 is a schematic diagram of a method for manufacturing an eyewear provided by some embodiments of the present disclosure;

FIG. 39 is a schematic diagram of another eyewear provided by some embodiments of the present disclosure;

FIG. 40 is a schematic diagram of another eyewear provided by some embodiments of the present disclosure;

FIG. 41 is a schematic diagram of another method for manufacturing an eyewear provided by some embodiments of the present disclosure;

FIG. 42 is a schematic diagram of another eyewear provided by some embodiments of the present disclosure;

FIG. 43 is a schematic diagram of disassembly of an eyewear shown in FIG. 42;

FIG. 44 is a schematic diagram of another eyewear provided by some embodiments of the present disclosure;

FIG. 45 is a schematic diagram of another eyewear provided by some embodiments of the present disclosure;

FIG. 46 is a schematic diagram of another eyewear provided by some embodiments of the present disclosure;

FIG. 47 is a schematic diagram of another eyewear provided by some embodiments of the present disclosure;

FIG. 48 is a schematic diagram of a disassembly of an eyewear shown in FIG. 47;

FIG. 49 is a schematic diagram of another eyewear provided by some embodiments of the present disclosure; and

FIG. 50 is a cross-sectional view along line C-C′ shown in FIG. 49.

### DESCRIPTION OF EMBODIMENTS

In order to make the purpose, technical solutions and advantages of the embodiments of the present disclosure clearer, the technical solutions in the embodiments of the present disclosure will be described clearly and completely below in conjunction with the accompanying drawings in the embodiments of the present disclosure, and it is clear that the embodiments described are some embodiments of the embodiments of the present disclosure, rather than all embodiments of the present disclosure. Based on the embodiments in the present disclosure, all other embodiments obtained by those of normal skill in the art fall within the scope of protection of the present disclosure.

The terms used in the embodiments of the present disclosure are merely for the purpose of describing particular embodiments and not intended to limit the present disclosure. Unless otherwise noted in the context, the expressions “a”, “an”, “the” and “the” in a singular form used in the embodiments and appended claims of the present disclosure are also intended to represent a plural form.

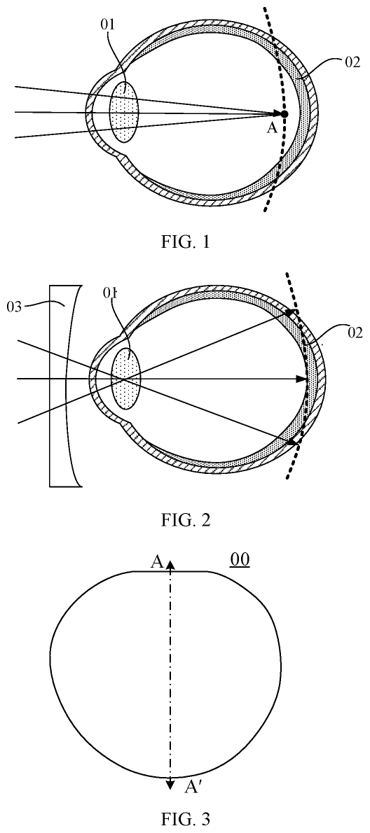

FIG. 1 is a schematic diagram of myopia imaging. FIG. 2 is a schematic diagram of imaging after correcting vision by a normal myopic lens. As shown in FIG. 1, the eye has a crystalline lens 01, and the crystalline lens 01 is a transparent biconvex lens and is one of the most important ocular refractive media in the human eyes. Due to ametropia of myopic eyes, external light is imaged at a position A that is in front of the retina 02 after passing through the crystalline lens 01.

The retina 02 includes a central visual field region responsible for imaging central vision of human eyes, and a peripheral visual field region responsible for imaging peripheral vision of the human eyes. The peripheral of the central vision is also referred to as the peripheral vision, and the peripheral vision is a vision range visible from the corner of the eye when the eye is gazing straight ahead. As shown in FIG. 2, after vision correction with normal myopic eyewear 03, an object image of central vision is imaged on the retina 02, while an object image of peripheral of the central vision is imaged behind the retina 02, and the dashed line in FIG. 2 indicates the imaging position. The peripheral hyperopic defocus is formed in the eye. Such peripheral hyperopic defocus state causes the retina to elongate backwards for self-regulation, causing increase of the length of the eye axis, thereby increasing the myopic diopter.

In related technologies, the growth of the eye axis backwards is controlled by wearing defocus eyewear to decrease the myopic diopter. The defocus eyewear can include defocus distributed multi-point (DDM) lenses. With the DDM lenses, a myopia defocus blurred image is formed through the DDM lenses so as to control the growth of the eye axis and slow down the progression of myopia. Although the DDM lenses can have an important stimulating effect on controlling the growth of the eye, once the DDM lenses is manufactured, the parts of the eye that can be stimulated by the multi-point defocusing lens, the size of these parts, and the stimulating manner are all fixed and not easy to be changed.

In order to solve the above technical problems, some embodiments of the present disclosure provide an eyewear. The eyewear includes a display functional layer and a light-guiding structure. With the cooperation between the display functional layer and the light-guiding structure, a specific light path is formed and forms an image at a specific position in the eye to stimulate the eye, so as to control the change of the shape of the eye axis and prevent deterioration of vision.

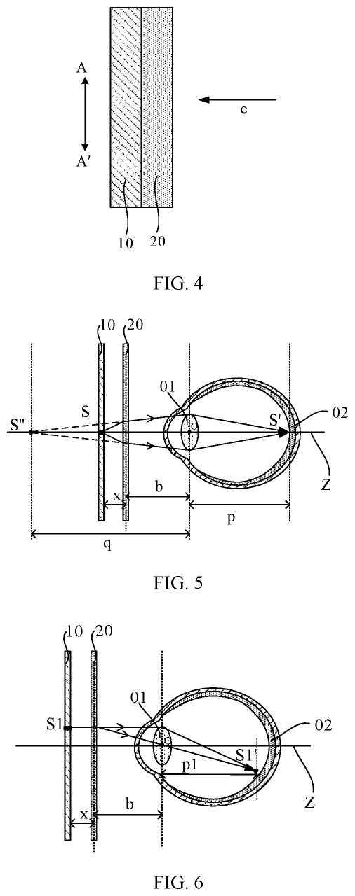

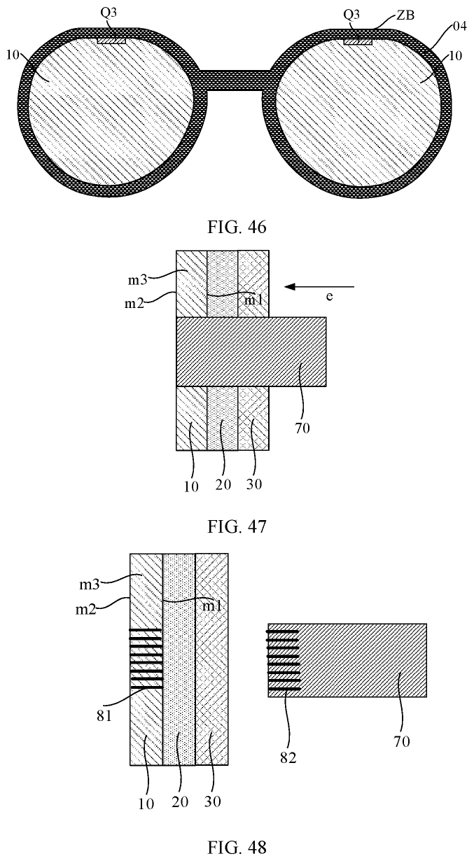

FIG. 3 is a partial schematic diagram of an eyewear provided by some embodiments of the present disclosure. FIG. 4 is a cross-sectional view along line A-A′ shown in FIG. 3. FIG. 5 is a schematic diagram of an imaging principle of an eyewear provided by some embodiments of the present disclosure. FIG. 3 schematically illustrates only a part covered by one lens 00 of an eyewear, and is a top view of the lens 00. The shape of lens 00 in FIG. 3 is only schematically illustrated, and is not intended to limit the present disclosure. The eyewear also includes structures such as eyewear frames, nose pads, and eyewear legs, which are not shown in FIG. 3. The structure of the eyewear can be understood in conjunction with FIG. 44 or FIG. 46.

As shown in FIG. 4, the eyewear includes a display functional layer 10 and a light-guiding structure 20, and the light-guiding structure 20 is located at a side of the display functional layer 10 facing towards a viewing surface. The viewing surface can be understood as a surface opposite-to (or away-from) the user's eyes when using the eyewear. An arrow in FIG. 4 illustrates a viewing direction e (i.e., gazing direction). In other words, when wearing the eyewear, a distance from the light-guiding structure 20 to the human eye is smaller than a distance from the display functional layer 10 to the human eye, that is, the light-guiding structure 20 is located at a side of the display functional layer 10 facing towards the human eye. In order to illustrate the relative position of the display functional layer 10 and the light-guiding structure 20, the light-guiding structure 20 in FIG. 4 is shown as a simplified illustration, and its specific structure will be described in the following relevant embodiments.

The display functional layer 10 has a function of light-emitting display and can be used as a light source, and light emitted from the display functional layer 10 enters the user's eyes after being guided by the light-guiding structure 20. The light-guiding structure 20 can be used to adjust the light path of the light irradiating to the eye. The light emitted from the display functional layer 10 enters the human eye after passing through the light-guiding structure 20, and is then imaged in the eye after passing through the crystalline lens.

As shown in FIG. 5, light emitted from a light-emitting point S of the display functional layer 10 is irradiated into the eye after the action of the light-guiding structure 20 and forms an image S′ on the retina 02 after the action of the crystalline lens 01 in the eye. The crystalline lens 01 is a convex lens, and a main axis Z of the crystalline lens 01 is illustrated. According to an imaging distance of the convex lens, an imaginary image S″ is formed at a side of the light-emitting point S away from the eye. An imaging distance p in the eye is a distance from an optical center O to the crystalline lens 01 and the image. When imaging on the retina 02, a distance from the optical center O to the crystalline lens 01 and the retina 02 is p. If imaging in the central visual field region of the retina 02, the imaging distance p is a distance from the optical center O to the crystalline lens 01 and the retina 02 along the main axis Z. The distance from the light-guiding structure 20 to the optical center O of the crystalline lens 01 is defined as a distance b from the eye to the light-guiding structure 20. A distance from the display functional layer 10 to the light-guiding structure 20 is x, and a distance from the virtual image S″ to the eye is q. In some embodiments, the light-guiding structure 20 includes a lens and has a focal length f₂₀, and the crystalline lens 01 has a focal length f_{eye}. The eye adjusts the crystalline lens 01 depending on whether it is viewing a distant object or viewing a facing towards object. When viewing a distant object, the crystalline lens 01 the crystalline lens 01 becomes thin and the focal length f_{eye} becomes larger. When viewing the facing towards object, the crystalline lens 01 becomes thick and the focal length f_{eye} becomes smaller. When the refractive power of the eye is fixed, a distance between the object and the eye is fixed, and then the focal length f_{eye} of the crystalline lens 01 is fixed.

According to the lens imaging formula, a relationship between an object distance, an image distance and the focal length is satisfied. For example, when the object distance and focal distance are determined, the image distance can be calculated. Applied to the eye imaging system, when the distance between the object and the eye and the focal length of the eye (i.e., the focal length of the crystalline lens) are known, the imaging distance in the eye can be determined. When the focal length of the eye remains the same, the imaging position in the eye can be adjusted by adjusting the distance between the object to the eye, for example, controlling the object is imaged on or in front of the retina. The principle of wearing myopia correction lenses is to add a lens with refractive index between the object and the eye, so as to change the light path of light of the object irradiating into the human eye, which leads the light to enter the human eye and then to be imaged on the retina after the action of the crystalline lens, thereby viewing objects clear.

The optical path diagram in FIG. 5 is illustrated by showing that the luminescent point S of the display functional layer 10 is imaged on the retina 02 of the eye and the image is located in the central visual field region of the retina 02. The eyes have individual differences, and when customizing the eyewear for a user, the distance between the optical center O of the crystalline lens 01 in the eye and the retina 02 can be determined, and a desired imaging distance in the eye can be determined based on a desired imaging position in the eye. For example, when the desired imaging position is located in the central visual field region of the retina 02, the desired imaging distance is approximately the distance between the optical center O of the crystalline lens 01 and the retina 02 along the main axis Z. The length of the eye axis of an adult is about 24 mm and generally ranges from 22 mm to 24 mm. Different people have different eye axes, and a given individual has the length of eye axis of a constant value, so the imaging distance p in the eye in the optical path diagram of FIG. 5 can be determined based on the length of the eye axis. When the user wears the eyewear, a distance between the lens of the eyewear and the human eye is fixed, so that the distance b from the eye to the light-guiding structure 20 can be determined. The optical path of the light emitted from the light-guiding structure 20 to the eye is adjusted by the cooperation between the focal length f of the light-guiding structure 20 and a distance x from the display functional layer 10 to the light-guiding structure 20. That is, the imaging distance p, the distance b from the eye to the light-guiding structure 20, the distance x from the display functional layer 10 to the light-guiding structure 20, the focal length f_{eye}, and the focal length f₂₀ of the light-guiding structure 20 are correlated. When the distance b from the eye to the light-guiding structure 20 and the focal length f_{eye} are fixed, the focal length f₂₀ of the light-guiding structure 20 and the distance x from the display functional layer 10 to the light-guiding structure 20 are matched to obtain the desired imaging distance p. The size of the desired imaging distance p is set to control the image to be formed on, in front of, or behind the retina 02. When the image is formed in front of the retina 02, a blurred pattern is visible by the user, and this myopia defocus stimulates the growth of the eye, improving the problem of eye axis elongation and slowing down the progression of myopia.

The display functional layer 10, serving as the light source, can display a variety of patterns, and a position of the display pattern, brightness of the pattern, chromaticity of the pattern, the display time of the pattern, and the like can be programmed and controlled, and the pattern is displayed with a strong initiative. The display functional layer 10 and the light-guiding structure 20 cooperate with each other to achieve an active defocus adjustment of the eyewear. The pattern displayed by the display functional layer 10 includes pattern information, and the pattern information includes signals, such as brightness of the pattern, chromaticity of the pattern, shape of the pattern, and size of the pattern. The positions where the pattern is displayed on the display functional layer 10 changes, or the pattern is displayed on the display functional layer 10 at the same time, then the image can be formed at different positions of the retina 02 of the eye to stimulate different parts of the eye. The size of the pattern displayed on the display functional layer 10 affects the size of the parts of the eye that are stimulated. The change of the brightness or chromaticity of the pattern displayed on the display functional layer 10 realizes that the eye is stimulated with different patterns, so as to prevent stimulation fatigue. The display time or display mode of the display functional layer 10 can be actively controlled, so as to adjust the duration of the stimulation to the eyes.

The eyewear provided by the embodiments of the present disclosure includes the display functional layer 10 and the light-guiding structure 20, the display functional layer 10 serving as the light source can display patterns, the light-guiding structure 20 is used as a light-path adjusting structure, and the display functional layer 10 and the light-guiding structure 20 cooperate with each other to adjust the imaging position of the patterns displayed on the display functional layer 10 in the eye. The imaging position of the pattern displayed on the display functional layer 10 is imaged on the retina 02, in front of the retina 02, or behind the retina 02 in the eye. When the imaging position of the display pattern in the eye is controlled to be formed out of the retina 02, a defocus state is formed and causes a blurred pattern that is visible by the user. The defocus state can be used to stimulate the growth of the eye to prevent and control the change in the length of the eye axis, thereby presenting the increase in visual diopters. In the embodiments, the display functional layer 10 and the light-guiding structure 20 cooperate with each other to achieve the active defocus adjustment, which can control at least the stimulated part, the size of the part, the stimulation duration, and the pattern information used for stimulation, and can be applied in multiple modes, increasing the user's participation and meeting the user's personal needs.

FIG. 6 is a schematic diagram of another imaging principle of an eyewear provided by some embodiments of the present disclosure. In some embodiments, as shown in FIG. 6, the light emitted from the light-emitting point S1 of the display functional layer 10 is irradiated into the eye after the action of the light-guiding structure 20, and then is imaged at the periphery of the central visual field region of the retina 02 after the action of the crystalline lens 01, that is, being imaged in the peripheral visual field region of the retina 02. The image S′ is in front of the retina 02. The distance from the image S′ to the optical center O of the crystalline lens 01 is p1, that is, the imaging distance in the eye is p1. With reference to the description of the imaging principle in the embodiments of FIG. 5, it can be understood that, with reasonable settings of the focal length f₂₀ of the light-guiding structure 20 and the distance x from the display functional layer 10 to the light-guiding structure 20, it is possible to make the image S′ be located in the peripheral visual field region of the retina 02 and be located in front of the retina 02. In this way, the retina 20 forms the myopic defocus in the peripheral visual field region. As shown in FIG. 2, the peripheral hyperopic defocus is formed when a myopic user wears a normal myopic eyewear. The peripheral hyperopic defocus causes the retina to extend backward for self-regulation, resulting in further increase in the length of the eye axis. Some embodiments of the present disclosure combine the myopic lenses with the adjustment device provided by some embodiments of the present disclosure (i.e., the device including the display functional layer 10 and the light-guiding structure 20), the peripheral myopic defocus is achieved when the myopic user wears the eyewear, and the peripheral myopic defocus causes that the blurred pattern is visible by the user in the peripheral visual field region. Such peripheral myopic defocus state can stimulate the eye, which prevents the retina from elongating backwards to increase the length of the eye axis, prevent and control further deterioration of vision and compensate for the defective problem of forming peripheral hyperopic defocus by the normal myopic lenses.

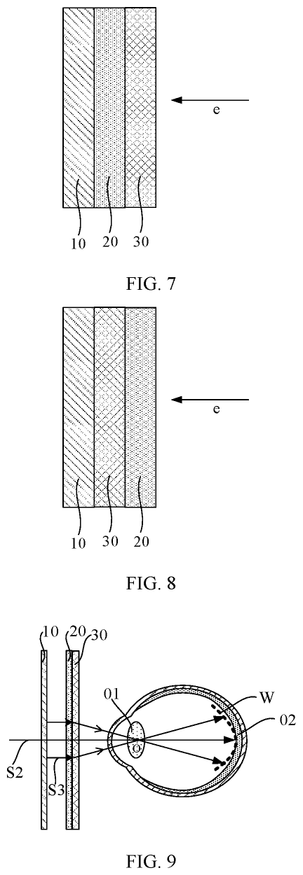

FIG. 7 is another cross-sectional view along line A-A′ shown in FIG. 3. FIG. 8 is another cross-sectional view along line A-A′ shown in FIG. 3. FIG. 9 is a simplified schematic diagram of an optical path of an eyewear provided by embodiments of FIG. 7. In some embodiments, as shown in FIG. 7, the eyewear also includes a myopia-correction structure 30 located at the side of the display functional layer 10 facing towards the viewing surface, and a viewing direction e is illustrated in FIG. 7. The myopia-correction structure 30 is located at a side of the light-guiding structure 20 facing away from the display functional layer 10. In other embodiments, as shown in FIG. 8, the myopia-correction structure 30 is located at a side of the light-guiding structure 20 facing towards the display functional layer 10. The myopia-correction structure 30 is a myopic lens with myopic diopters, and the myopia-correction structure 30 provides normal vision correction to the eye. As illustrated in FIG. 7 or FIG. 8, the myopia-correction structure 30 overlaps with the light-guiding structure 20.

As shown in FIG. 9, the imaging position in the eye after wearing the eyewear provided by some embodiments of the present disclosure is located at a dashed line W. Light beam S2 is a light beam emitted from an object located at the central visual field of the eye to the eye, and light beam S3 is a light beam emitted from the display functional layer 10 to the eye. It can be seen that the imaging position of the light beam S2 is located in the central visual field region of the retina 02 and no defocus occurs. The imaging position of the light beam S3 is in front of the peripheral visual field region of the retina 02, forming a myopic defocus. In this way, the central vision includes no defocus, and a peripheral vision includes the myopic defocus. The image formed by the light beam S2 in the eye is the image formed by the real environment in the eye, while the light beam S3 provided by the eyewear forms an image in the eye that is an image displayed by the display functional layer 10 in the eye. After the light beam S2 is imaged in the eye, objects in the real environment in front of the eye can be visible to the eye. The final imaging position of the light beam S3 from the display functional layer 10 is within the peripheral visual field of the retina, so the normal viewing real objects in front of the eyewear user will not be affected. When wearing the eyewear, the user can clearly see objects at the central vision without affecting normal life and work; at the same time, the user is able to stimulate the eyes through the peripheral vision myopic defocus to prevent the myopic diopter from increasing. The user can also work and live normally while wearing eyewear, and the time to wear eyewear to prevent myopia is more flexible.

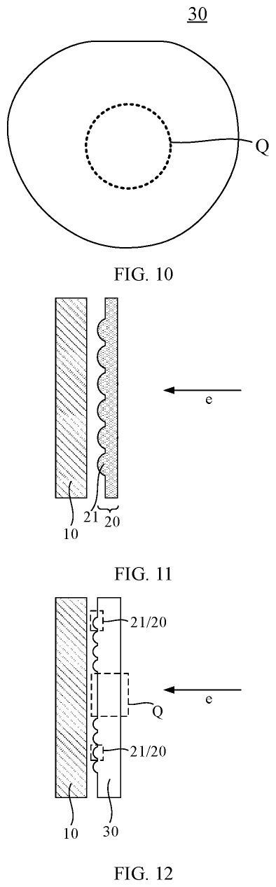

FIG. 10 is a schematic diagram of a myopia correction of an eyewear provided by some embodiments of the present disclosure. A shape of a top view of the myopia-correction structure 30 is similar to the shape of the lens of the eyewear, and the shape of the top view of the myopia-correction structure 30 in FIG. 10 is only a schematic illustration, which does not limit the present disclosure. As shown in FIG. 10, the myopia-correction structure 30 has a central region Q, which corresponds to the central visual field region of the retina 02. It can be understood in conjunction with the embodiments of FIG. 9 that, after wearing the eyewear provided by the embodiments of the present disclosure, the user sees objects at the central visual field through the central region Q of the myopia-correction structure 30.

FIG. 11 is another cross-sectional view along line A-A′ shown in FIG. 3. In some embodiments, as shown in FIG. 11, the light-guiding structure 20 includes microstructures 21, and the microstructures 21 are convex lenses. The convex lens has a convex side protruding towards the display functional layer 10. The convex lens has a function of converging light. In the application, the light emitted from the display functional layer 10 is first irradiated to the light-guiding structure 20, and the microstructures 21 in the light-guiding structure 20 converge light and adjust the light path of the light, so that the light irradiated into the eye after the adjustment can be imaged at a predetermined position within the eye.

FIG. 12 is another cross-sectional view along line A-A′ shown in FIG. 3. In some other embodiments, as shown in FIG. 12, the myopia-correction structure 30 and the light-guiding structure 20 are formed into one piece. The light-guiding structure 20 illustrated in FIG. 12 includes multiple microstructures 21. The myopia-correction structure 30 includes a central region Q. In some embodiments, the microstructures 21 are located on the periphery of the central region Q. The embodiments set the myopia-correction structure 30 and the light-guiding structure 20 to be formed into one piece, which facilitates the thinning of the thickness of the lens including the display functional layer 10, the myopia-correction structure 30 and the light-guiding structure 20, thus improving the aesthetics of the eyewear.

FIG. 13 is another cross-sectional view along line A-A′ shown in FIG. 3. In some embodiments, as shown in FIG. 13, the light-guiding structure 20 and the myopia-correction structure 30 together form an optical structure 2-3, and a media layer 40 is filled (configured) between the optical structure 2-3 and the display functional layer 10. The media layer 40 includes, but is not limited to, a grease for adjusting dielectric constant. When the light-guiding structure 20 is located between the display functional layer 10 and the myopic correction structure 30, the media layer 40 is in contact with the light-guiding structure 20, and the light emitted from the display functional layer 10 first enters the media layer 40, and then enters the light-guiding structure 20 via the media layer 40. The media layer 40 can be used to adjust the refractive index of the interface, and a curvature of the lens in the light-guiding structure 20 is adjusted according to the dielectric constant of the media layer 40 to ensure that the pattern displayed on the display functional layer 10 can be imaged at a predetermined position in the eye.

FIG. 13 illustrates that the light-guiding structure 20 in optical structure 2-3 is located at the side of the myopia-correction structure 30 facing towards the display functional layer 10. In other embodiments, the myopia-correction structure 30 in optical structures 2-3 is located at the side of the light-guiding structure 20 facing towards the display functional layer 10. In other embodiments, the myopia-correction structure 30 in the optical structure 2-3 and the light-guiding structure 20 are formed into one piece. Such configurations are not shown in drawings herein.

In one manufacturing method, the media layer 40 is formed on one side of the display functional layer 10, and then the optical structure 2-3 is attached on one side of the media layer 40. In this process, it is required that the myopia-correction structure 30 and the light-guiding structure 20 are first attached to each other to form the optical structure 2-3, or the myopia-correction structure 30 and the light-guiding structure 20 are formed into one piece to obtain the optical structure 2-3.

For example, the myopia-correction structure 30 is located at the side of the light-guiding structure 20 facing towards the display functional layer 10. In another manufacturing method, the media layer 40 is formed on one side of the display functional layer 10, and then the myopia-correction structure 30 and the light-guiding structure 20 are sequentially attached on one side of the media layer 40.

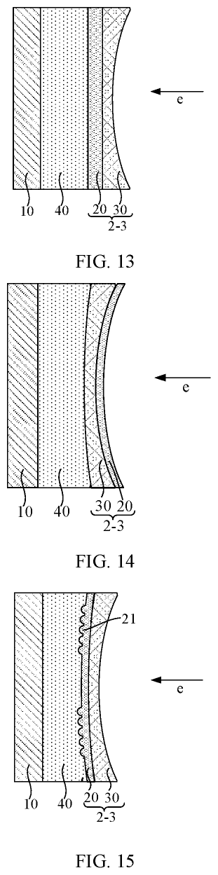

FIG. 14 is another cross-sectional view along line A-A′ shown in FIG. 3. In some embodiments, as shown in FIG. 14, a surface of the media layer 40 and a surface of the optical structure 2-3 are in contact with each other and are cambered surfaces. That is, the surface of the media layer 40 facing towards the optical structure 2-3 matches the surface of the optical structure 2-3 facing towards the media layer 40. The myopia-correction structure 30 of the optical structure 2-3 is located on the side of the light-guiding structure 20 facing towards the display functional layer 10. In one manufacturing method, the media layer 40 is first formed on one side of the display functional layer 10, and the surface of the media layer 40 facing away from the display functional layer 10 is formed as a cambered surface; then the myopia-correction structure 30 is attached on the side of the media layer 40 facing away from the display functional layer 10, and then the light-guiding structure 20 is attached thereto. The surface of the myopia-correction structure 30 facing towards the display functional layer 10 is a cambered surface. In the manufacturing process, the surface of the media layer 40 facing away from the display functional layer 10 is formed as a cambered surface, which can guide and be in alignment with the myopia-correction structure 30 attached on the side of the media layer 40, simplify the difficulty of the attaching process, and ensure the attachment accuracy.

FIG. 15 is another cross-sectional view along line A-A′ shown in FIG. 3. In some embodiments, as shown in FIG. 15, the surface of the media layer 40 and the surface of the optical structure 2-3 that are in contact with each other are cambered surfaces, and concave microstructures and convex microstructures are provided on the cambered surfaces. The surface of the media layer 40 and the surface of the optical structure 2-3 that are in contact with each other as a whole are cambered surfaces. When the light-guiding structure 20 of the optical structure 2-3 is located on the side of the myopia-correction structure 30 facing towards the display functional layer 10, the light-guiding structure 20 includes microstructures 21. In some embodiments, the microstructures 21 are convex lenses. In a manufacturing method, firstly, the media layer 40 is formed on one side of the display functional layer 10, the surface of the media layer 40 facing away from the side of the display functional layer 10 is a cambered surface, and a recess is provided on the cambered surface of the media layer 40 at a predetermined position; and then the light-guiding structure 20 is attached to the media layer 40, then the recess in the cambered surface of the media layer 40 can guide the alignment of the attachment of the light-guiding structure 20, so that microstructure 21 is embedded in the recess. In this way, the surface of the media layer 40 and the surface of the optical structures 2-3 that are in contact with each other are formed as cambered surface ultimately, and the concave microstructures and the convex microstructures are provided on the cambered surfaces.

FIG. 14 and FIG. 15 illustrate that two surfaces at two sides of the myopia-correction structure 30 are cambered surfaces, and the two cambered surfaces are recessed in a same direction when view from the viewing direction e. The two cambered surfaces of the myopia-correction structure 30 have different curvatures, and the thickness of the myopia-correction structure 30 gradually becomes larger from a center of the myopia-correction structure 30 to an outer side of the myopia-correction structure 30.

In some other embodiments, as shown in FIG. 13, the surface of the myopia-correction structure 30 facing away from the display functional layer 10 is a cambered surface, and the surface of the myopia-correction structure 30 facing towards the display functional layer 10 is a flat surface. The thickness of the myopia-correction structure 30 gradually becomes larger from the center of the myopia-correction structure 30 to the outer side of the myopia-correction structure 30.

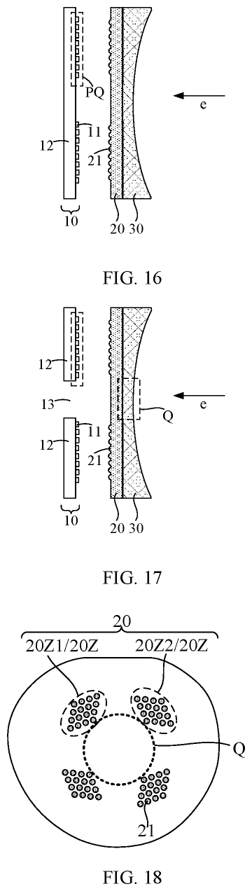

FIG. 16 is another cross-sectional view along line A-A′ shown in FIG. 3. In some embodiments, as shown in FIG. 16, the display functional layer 10 has a pixel region PQ where light-emitting elements 11 are provided, and the light-guiding structure 20 and the pixel region PQ at least partially overlap along the viewing direction e. The pixel region PQ is a region capable of displaying a functional pattern. The functional pattern is a pattern displayed on the display functional layer 10 in a therapeutic mode when the user is wearing the eyewear. When the user is wearing the eyewear, the functional pattern is imaged at a specific location in the eye after the action of the light-guiding structure 20. In the embodiments, the light-guiding structure 20 at least partially overlaps with the pixel region PQ, which can ensure that light from the pixel region PQ enters the light-guiding structure 20 to be imaged at a specific location in the eye using the functional pattern displayed in the pixel region PQ.

As shown in FIG. 16, the light-guiding structure 20 includes microstructures 21, and the microstructures 21 at least partially overlaps with the pixel region PQ along the viewing direction e.

In some embodiments, the light-guiding structure 20 includes microstructures 21, and one microstructure 21 corresponds to multiple light-emitting elements 11. The microstructure 21 acts on light emitted from the multiple light-emitting elements 11, which can ensure the brightness of the pattern imaged by the light after entering the eye with the action of the microstructure 21, and the multiple microstructures 21 cooperate to enable that the imaging formed by the functional pattern in the eye are relatively fine.

As shown in FIG. 16, the display functional layer 10 also includes a substrate 12, the light-emitting elements 11 are located on a side of the substrate 12, and FIG. 16 only illustrates that the light-emitting elements 11 are located on a side of the substrate 12 facing towards the light-guiding structure 20. In other embodiments, the light-emitting elements 11 are located on a side of the substrate 12 facing away from the light-guiding structure 20. Regardless of which side of the substrate 12 the light-emitting elements 11 are located, the light-emitting elements 11 are provided in the embodiments of the present disclosure emit light towards the light-guiding structure 20. In some embodiments, the display functional layer 10 also includes a driver layer, and the driver layer includes a pixel circuit, and the pixel circuit is configured to drive the light-emitting element 11.

In some embodiments, the light-emitting element 11 is a light-emitting diode. The light-emitting element 11 is an organic light-emitting diode or an inorganic light-emitting diode. When taking the light-emitting diodes as the light-emitting elements 11, there are relatively large advantages in light-emitting brightness, resolution, response speed, service life, energy consumption, and so on.

In one embodiment, the light-emitting element 11 is a micro light-emitting diode, i.e., Micro-LED.

In some embodiments of the present disclosure, the display functional layer 10 is a display panel, and the display panel is a display panel that can autonomously emit light and that includes at least a substrate, an array layer, a light-emitting layer, and other layers. The light-emitting layer includes the light-emitting elements. In the manufacturing process, the array layer, light-emitting layer and other layers are sequentially formed on the substrate to form the display functional layer 10; then the display functional layer 10 is attached to another structure. For example, the display functional layer 10 is attached to the light-guiding structure 20, and then to the myopia-correction structure 30. In another example, the light-guiding structure 20 is attached to the myopia-correction structure 30 to form a combined structure, and then the display functional layer 10 is attached to the combined structure.

In some embodiments, the display functional layer 10 is a transparent display panel, then the display functional layer 10 has a high light transmittance. When the user wears the eyewear, light from the object in front of the eyewear can normally pass through the display functional layer 10, the light-guiding structure 20 and the myopia-correction structure 30, and finally enter the eyes, which can ensure the clarity of the user's vision. In some embodiments of the present disclosure, the positions of the light-guiding structure 20 and the myopia-correction structure 30 relative to the display functional layer 10 can be interchanged. Some embodiments only illustrate that the light-guiding structure 20 is located between the display functional layer 10 and the myopia-correction structure 30. Embodiments where the light-guiding structure 20 is located on the side of the myopia-correction structure 30 facing away from the display functional layer 10 can be understood with reference the above.

FIG. 17 is another cross-sectional view along line A-A′ shown in FIG. 3. In some embodiments, as shown in FIG. 17, the display functional layer 10 has a hollow 13 at a position where the display functional layer 10 overlaps with the central region Q of the myopia-correction structure 30 in the viewing direction e. The light-emitting elements 11 in the display functional layer 10 does not overlap with the central region Q in the viewing direction e. In other words, the display functional layer 10 is hollowed out at its position corresponding to the central region Q. Such configuration can improve the light transmittance of the central region Q and ensure that the user can clearly see the object at the central of the vision after wearing the eyewear.

FIG. 18 shows a schematic diagram of another eyewear provided by some embodiments of the present disclosure. FIG. 18 a schematic view when viewing from the light-guiding structure 20 to the myopia-correction structure 30. In some embodiments, as shown in FIG. 18, the light-guiding structure 20 includes a light-guiding group 20Z, the light-guiding group 20Z includes microstructures 21, and a distance between two adjacent light-guiding groups 20Z is greater than a distance between two microstructures 21 within the light-guiding group 20Z. The number of light-guiding groups 20Z in the light-guiding structure 20 is not limited, and only four light-guiding groups 20Z are illustrated in FIG. 18. The numbers and arrangements of the microstructures 21 in the light-guiding groups 20Z can be the same or different from each other. In some embodiments, the light-guiding groups 20Z are arranged at intervals in an island-shape. With the light-guiding function of the light-guiding group 20Z to the light emitted by the display functional layer 10, it can be set that a region of one display pattern corresponds to a light-guiding group 20Z, so as to prevent interference between the light of different functional patterns, and also to reduce the light loss of the functional patterns, which ensures that the blurring degree of the image formed by the functional patterns in the eye meets the demand. A region between adjacent light-guiding groups 20Z can transmit light normally, and no microstructure 21 will interfere the light penetrating the region between the adjacent light-guiding groups 20Z. Then vision correction can be achieved after the light penetrating the region between the adjacent light-guiding groups 20Z enters the eye, so that a clear pattern is visible to the eye. In this way, a sharp contrast can be formed between a clear pattern and a blurred pattern, which enhances stimulation to the eye.

In some embodiments, the light-guiding structure 20 as a whole is a film, and the light-guiding structure 20 and the myopia-correction structuremyopia-correction structure 30 have a same shape.

In some embodiments, the myopia-correction structure 30 has a central region Q. The central region Q can be understood with reference to the above description for FIG. 10. In FIG. 18, the myopia-correction structure 30 is below the light-guiding structure 20, and the location of the central region Q of the myopia-correction structure 30 is also illustrated. The light-guiding structure 20 at least partially surrounds the central region Q. In some embodiments, as shown in FIG. 18, the light-guiding groups 20Z surround the central region Q. In the embodiments, no microstructure 21 is provided at the position where the light-guiding structure 20 overlaps with the central region Q of the myopia-correction structure 30, so the light at the central vision is not affected by the microstructures 21, which can ensure the imaging effect in the central visual field region of the eye. The user can clearly see the object image at the central vision through the central visual field region when wearing the eyewear, ensuring that the user can live and work normally when wearing the eyewear.

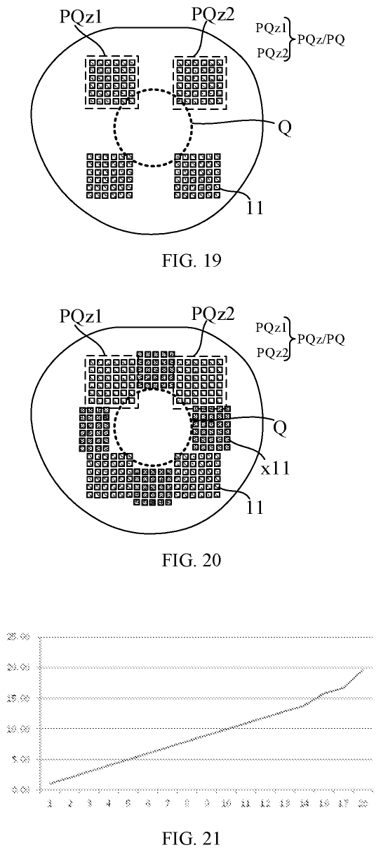

FIG. 19 is a schematic diagram of another eyewear provided by some embodiments of the present disclosure. FIG. 19 is a schematic diagram when viewing from the display functional layer 10 towards the light-guiding structure 20. In some embodiments, as shown in FIG. 19, the pixel region PQ include pixel sub-regions PQz, the pixel sub-regions PQz include a first pixel sub-region PQz1 and a second pixel sub-region PQz2, and a distance between the first pixel sub-region PQz1 and the second pixel sub-region PQz2 is greater than a distance between two light-emitting elements 11 within the pixel sub-region PQz. FIG. 19 only schematically illustrates the arrangement for the light-emitting elements 11 within the pixel sub-region PQz, which does not limit the present disclosure.

In combination with FIG. 18, the light-guiding groups 20Z include a first light-guiding group 20Z1 and a second light-guiding group 20Z2, the first light-guiding group 20Z1 overlaps with the first pixel sub-region PQz1, and the second light-guiding group 20Z2 overlaps with the second pixel sub-region PQz2. In the operating mode, the first light-guiding group 20Z1 acts on light emitted from the first pixel sub-region PQz1 towards the eye, so that light having a changed light path can enter the eye and be imaged at a specific location in the eye. The second light-guiding group 20Z2 acts on light emitted from the second pixel sub-region PQz2 toward the eye, so that light having a changed light path can enter the eye and be imaged at a specific location in the eye. In the embodiments, each pixel sub-region PQz corresponds to one light-guiding group 20Z, and the light-emitting element 11 or no light-emitting element 11 can be provided between adjacent pixel sub-regions PQz. FIG. 19 illustrates that no light-emitting element 11 is provided between adjacent pixel sub-regions PQz. Such configuration can improve the light transmittance of the display functional layer 10 and improve the clarity of the front viewed object when the user wears the eyewear.

FIG. 20 is a schematic diagram of another eyewear provided by some embodiments of the present disclosure. FIG. 20 is a schematic diagram when viewing from the display functional layer 10 towards the light-guiding structure 20. In another embodiment, as shown in FIG. 20, the display functional layer 10 also includes a dummy light-emitting element x11 disposed between adjacent pixel sub-regions PQz. In the therapeutic mode of the eyewear, the dummy light-emitting element x11 does not emit light. The dummy light-emitting element x11 and the light-emitting element 11 are formed in the same process, and with the dummy light-emitting element x11, the uniformity of the etching during the manufacturing process and the same performance of all light-emitting elements 11 can be ensured.

In some embodiments, the light-emitting element 11 is connected to the pixel circuit, and the dummy light-emitting element x11 is disposed in a region between the pixel sub-regions PQz, and the dummy light-emitting element x11 is disconnected from the pixel circuit. Therefore, no pixel circuit is provided at a location overlapping the dummy light-emitting element x11, which can improve the light transmittance of the display functional layer 10.

In some embodiments, the myopia-correction structure 30 includes a central region Q. The central region Q can be understood with reference to the above description for FIG. 10. In FIG. 19 and FIG. 20, the myopia-correction structure 30 is below the display functional layer 10, the location of the central region Q of the myopia-correction structure 30 is illustrated, and the pixel regions PQ at least partially surround the central region Q. That is, the pixel regions PQ surround the central region Q. In the embodiments, if no pixel region PQ is provided at the position overlapping with the central region Q of the myopia-correction structure 30, the light at the center vision is not blocked by the light-emitting elements 11, and the light transmittance at the central region Q is improved, which ensures the imaging effect of the central visual field region of the eye. Users can clearly see the object image at the central vision through the central visual field region when wearing eyewear, which ensures that they can live and work normally when wearing the eyewear.

In the embodiments of the present disclosure, a simulation test is performed to calculate a relationship between a distance x from the display functional layer 10 to the light-guiding structure 20 and the focal length f₂₀ of the convex lens in the light-guiding structure 20. FIG. 21 is a curve representing a relationship between a layer distance and a lens focal length obtained from a simulation test. The layer distance is the distance x from the display functional layer 10 to the light-guiding structure 20, and the lens focal length is the focal length f₂₀ of the convex lens. The conditions of the simulation test include: a distance between the object from the eye being 1 m, the focal length of the lens of the eye f_{eye} being 21.05 mm, a distance b from the eye to the light-guiding structure 20 being 10 mm, and a distance from the crystalline lens to the retina in the eye being 21 mm. With the configuration where the imaging distance p in the eye satisfies: p=21.5±0.2, the relationship curve illustrated in FIG. 21 is obtained. In FIG. 21, the horizontal coordinate indicates the distance x, in mm, from the display functional layer 10 to the light-guiding structure 20, and the vertical coordinate indicates the focal length f₂₀, in mm, of the convex lens. It can be seen from FIG. 21 that a certain relationship is shown between x and f₂₀, and in order to ensure that the mage is formed at a specific location in the eye, f₂₀ becomes larger as x becomes larger.

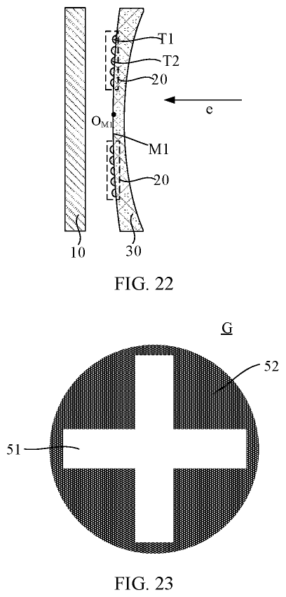

FIG. 22 is another cross-sectional view along line A-A′ shown in FIG. 3. In some embodiments, as shown in FIG. 22, a first surface M1 of the myopia-correction structure 30 facing towards the light-guiding structure 20 is a cambered surface and has a geometric center O_{M1}, the convex lenses in the light-guiding structure 20 include a first convex lens T1 and a second convex lens T2 that have different focal lengths, and a distance from the first convex lens T1 to the geometric center O_{M1} is different from a distance from the second convex lens T2 to the geometric center O_{M1}. When the surface of the light-guiding structure 20 in contact with the myopia-correction structure 30 is a cambered surface, the distances from the convex lenses located at different positions of the cambered surface to the display functional layer 10 will be different from each other. FIG. 22 illustrates that the distance between the second convex lens T2 and the geometric center O_{M1} along the viewing direction e is smaller than the distance between the first convex lens T1 and the geometric center O_{M1} along the viewing direction e. According to the relationship curve between x and f₂₀ illustrated in FIG. 21, the focal length of the second convex lens T2 can be set to be smaller than the focal length of the first convex lens T1. Such configuration ensures that the light acted by the first convex lens T1 and the second convex lens T2 can both be imaged at a specific position (or at a predetermined position) in the eye.

In some embodiments, the focal length of the convex lens is related to its area, height, and other parameters. At least one of the area or the height of the first convex lens T1 is different from that of the second convex lens T2, so that the focal length of the first convex lens T1 is different from the focal length of the second convex lens T2.

In some embodiments, the eyewear includes a therapeutic mode in which at least one pixel sub-region PQZ of the display functional layer 10 emits light to show a functional pattern. The functional pattern has a shape, such as, a cross shape, a shape of [symbol] , a shape of “ [symbol] —”, or other shapes. The functional pattern is formed by cooperation between light-emitting elements 11 within the sub-pixel region PQZ. The light emitted from the light-emitting elements 11 within the sub-pixel region PQZ is irradiated into the light-guiding structure 20, and enters the eye after the action of the light-guiding structure 20, and is eventually imaged at a specific location in the eye, and the image formed in the eye is the same as the functional pattern. In some embodiments of the present disclosure, the imaging position of the functional pattern is designed to be located in the peripheral visual field region of the eye and in front of the retina, which forms a peripheral myopic defocus to make the user view a blurred pattern. When wearing the eyewear, the peripheral myopic defocus is used to stimulate the growth of the eye to control the change in the length of the eye axis and to prevent and control the increase of the myopic diopter. In the embodiments of the disclosure, the display functional layer 10 is configured to display the functional pattern, and the functional pattern is formed in a better active way. The display functional layer 10 and the light-guiding structure 20 can cooperate with each other to achieve active defocus adjustment, and can control at least the stimulating part, the size of the part, the duration of the stimulation, the pattern information used for stimulation, and so on, which can applied in multiple modes, and increase participation of the user, and can meet personal needs of the user.

In some embodiments, the display functional layer 10 has a redundant region that is the region spaced between adjacent pixel sub-regions PQz as illustrated in FIG. 19, and the redundant region does not display images in the therapeutic mode. In the embodiments as shown in FIG. 19, no light-emitting element 11 is provided in the redundant region. In the embodiments as shown in FIG. 20, the dummy light-emitting elements 11 are provided in the redundant region, and the functional pattern is formed without the dummy light-emitting element 11 in the therapeutic mode. In the therapeutic mode, the display functional layer 10 displays the functional pattern and stimulates the growth of the eye using the image of the blurred pattern formed in the eye by the functional pattern. With the configuration where the redundant region does not display images, the redundant region can serve as a light-transmitting region in the therapeutic mode, and light from objects in front of the eyewear can enter the eyes not only through the central region Q of the myopia-correction structure 30 but also through the redundant region, which can increase the viewing region in the therapeutic mode. In this way, the user can still see objects in front of the user in the therapeutic mode clearly after wearing the eyewear, and the therapeutic mode is used to stimulate the growth of the eyes without affecting the user's normal life and work.

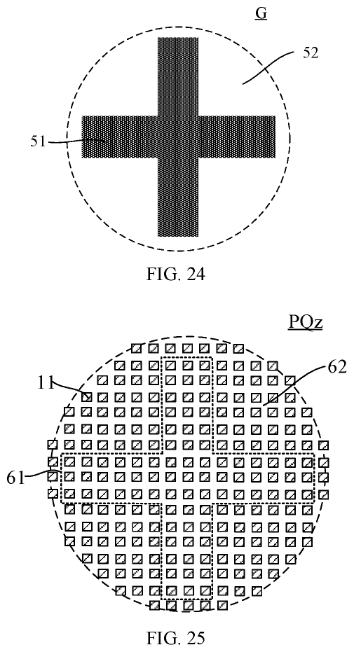

FIG. 23 is a schematic diagram of a functional pattern provided by some embodiments of the present disclosure. FIG. 24 is a schematic diagram of another functional pattern provided by some embodiments of the present disclosure. In some embodiments, the cross-shaped functional pattern Gas an example, as shown in FIG. 23, a region for forming the functional pattern G includes a first region 51 and a second region 52, the first region 51 is a pattern outline region, and the first region 51 and the second region 52 set off against each other, making the outline of the shape of the functional pattern G clearly prominent. As an example, white filling in the region indicates that no light is emitted therefrom, and black filling indicates that light is emitted there from. The second region 52 is shown by the pixel sub-region PQz when light is emitted from the pixel sub-region PQz, while the first region 51 is presented by the pixel sub-region PQz when no light is emitted from the pixel sub-region PQz. FIG. 24 illustrates the functional pattern G, the second region 52 is presented by the pixel sub-region PQz when no light is emitted from the pixel sub-region PQz, while the first region 51 is presented by the pixel sub-region PQz when light is emitted from the pixel sub-region PQz.

FIG. 25 is a schematic diagram of a pixel sub-region in an eyewear provided by some embodiments of the present disclosure. As shown in FIG. 25, the sub-pixel region PQz includes a graphic region 61 and a peripheral region 62. With reference to FIG. 23 and FIG. 24, the graphic region 61 and the functional pattern G have a same shape. The first region 51 corresponds to the graphic region 61, and the second region 52 corresponds to the peripheral region 62. When the graphic region 61 does emit light and the peripheral region 62 emits light, the pixel sub-region PQz can display the functional pattern G illustrated in FIG. 21. When the graphic region 61 emits light and the peripheral region 62 does not emit light, the pixel sub-region PQz can display the functional pattern G illustrated in FIG. 22.

In the embodiments of the present disclosure, the pixel sub-region PQz includes the graphic region 61 and the peripheral region 62, and the light-emitting state of the graphic region 61 and the light-emitting state of the peripheral region 62 are controlled to realize the display of the functional pattern G in the therapeutic mode. In some embodiments, the peripheral region 62 is located at the periphery of the graphic region 61.

In some embodiments, as shown in FIG. 25, multiple light-emitting elements 11 are provided in the graphic region 61, and other multiple light-emitting elements 11 are provided in the peripheral region 62, then both the graphic region 61 and the peripheral region 62 are capable of emitting light. In fact, when the display functional layer 10 does not emit light, there is no significant difference between the graphic region 61 and the peripheral region 62 of the pixel sub-region PQz. When the functional pattern G is displayed in the therapeutic mode, it is possible to distinguish the graphic region 61 from the peripheral region 62. That is, the shape of the graphic region 61 may not be fixed, and the shape of the graphic region 61 changes with the shape of the functional pattern G to be displayed. The eyewear provided by the embodiments of the present disclosure, the display functional layer 10 serving as the light source is used to display the functional pattern G, the shape of the functional pattern G is not limited to a single shape, and by programming the design, it is possible to utilize the pixel sub-region PQz to display the functional pattern G with different shapes to realize diverse therapeutic modes, which can prevent the eye from stimulation fatigue caused by a single pattern.

The contour shape of the sub-pixel region PQz is shown in FIG. 25 only as an approximate circle, which does not limit the present disclosure. The contour shape of the pixel sub-region PQz can also be rectangular, scalloped, cross-shaped or wavy.

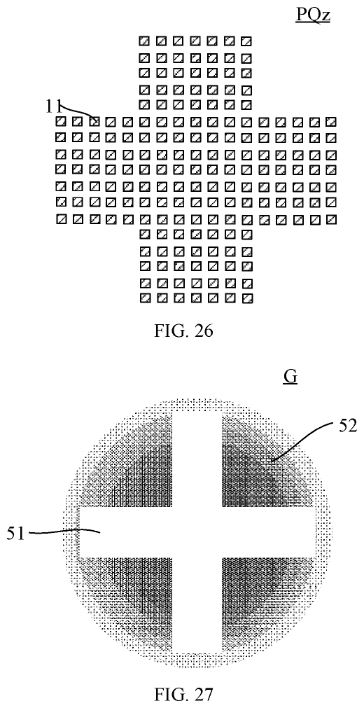

FIG. 26 is a schematic diagram of another pixel sub-region in an eyewear provided by some embodiments of the present disclosure. In some embodiments, as shown in FIG. 26, the contour shape of the sub-pixel region PQz is substantially cross-shaped. In one therapeutic mode, the sub-pixel region PQz in FIG. 26 is divided into a graphic region 61 and a peripheral region 62 when displaying the functional pattern G. In another therapeutic mode, the sub-pixel region PQz in FIG. 26 is equivalent to the graphic region, and all of the light-emitting elements 11 within the sub-pixel region PQz are involved in the display of the functional pattern G.

In some embodiments, in the therapeutic mode, the sub-pixel region PQz displays a functional pattern with gradually changed brightness. FIG. 27 is a schematic diagram of another functional pattern provided by some embodiments of the present disclosure. In some embodiments, as shown in FIG. 27, the functional pattern G includes a first region 51 and a second region 52, the first region 51 is a pattern outline region, and the second region 52 has gradually changed brightness. In combination with FIG. 25, the graphic region 61 can be controlled not to emit light, and the peripheral region 62 can be controlled to have gradually changed brightness, so that the pixel sub-region PQz displays the functional pattern G with gradually changed brightness. In some embodiments, brightness of the light-emitting elements 11 within the peripheral region 62 is controlled to gradually change in the direction from the peripheral region 62 towards the center of the graphic region 61. The gradually changed brightness includes two types of displaying manners, that is, the gradually increased brightness and the gradually decreased brightness.

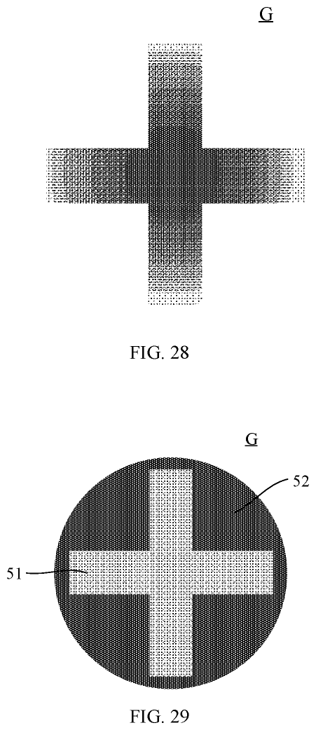

FIG. 28 is a schematic diagram of another functional pattern provided by some embodiments of the present disclosure. In one embodiment, as shown in FIG. 28, the functional pattern G displays with brightness gradually changing from the center of the functional pattern G towards the periphery of the functional pattern G, and the gradually changed brightness can be a gradually increased brightness or a gradually decreased brightness. By controlling the brightness of the light-emitting elements 11 in the region of the pixel sub-region PQz that has the same shape as the functional pattern G, it can be realized that the pixel sub-region PQz displays a functional pattern with gradually changed brightness.

In some other embodiments, in the therapeutic mode, the pixel sub-region PQz can display a functional pattern with gradually changed colors. The functional pattern with the gradually changed colors can be realized with reference to the above embodiments of realizing the functional pattern with gradually changed brightness. In one embodiment, the graphic region 61 does not emit light, the peripheral region 62 is located at the periphery of the graphic region 61, and the colors in the peripheral region 62 change gradually from the peripheral region 62 towards the center of the graphic region 61, to display the functional pattern with the gradually changed colors. In another embodiment, the colors in the graphic region 61 gradually change to display the functional pattern with gradually changed colors. Such configuration will not be shown in figures herein.

FIG. 29 is a schematic diagram of another functional pattern provided by some embodiments of the present disclosure. In some embodiments, as shown in FIG. 29, the first region 51 and the second region 52 within the functional pattern G have different brightness. With reference to the pixel sub-region PQz illustrated in FIG. 23, in the therapeutic mode, the luminous brightness of the graphic region 61 and the luminous brightness of the peripheral region 62 are controlled to be different to show the functional pattern G illustrated in FIG. 27. It can be that the luminous brightness of the graphic region 61 is greater than the luminous brightness of the peripheral region 62, or it can be that the luminous brightness of the graphic region 61 is smaller than the luminous brightness of the peripheral region 62. In the embodiments, the brightness difference between the graphic region 61 and the peripheral region 62 is set off against each other to make the contour of the shape of the functional pattern G clearly prominent.

In some embodiments, in the therapeutic mode, at least one pixel sub-region PQz emits light of a single color to shown the functional pattern. The single color is not limited to the conventional three base colors of red, green, and blue. The single color can also be a composite color formed by cooperation between the light-emitting elements 11 emitting light of two or three colors. Take FIG. 25 as an example, the graphic region 61 is controlled to emit red light while the peripheral region 62 is controlled to not emit light, so that the pixel sub-region PQz displays a single color to show the functional pattern. For example, the peripheral region 62 can be controlled to emit red light while the graphic region 61 is controlled to not emit light, so that the pixel sub-region PQz displays the single color to show the functional pattern.

In some embodiments, in the therapeutic mode, the pixel sub-region PQz emits red light to show the functional pattern. Viewing red light can assist in improving decreasing vision, red light is used to form the functional pattern, which can help to improve the stimulation effect on the eye in the therapeutic mode.

In the above embodiment, the display method for displaying the functional pattern G in pixel sub-region PQz is illustrated with the functional pattern G in the shape of a cross. The display method for the functional pattern G with other shapes can be understood with reference to the above embodiments, and will not be repeated herein.

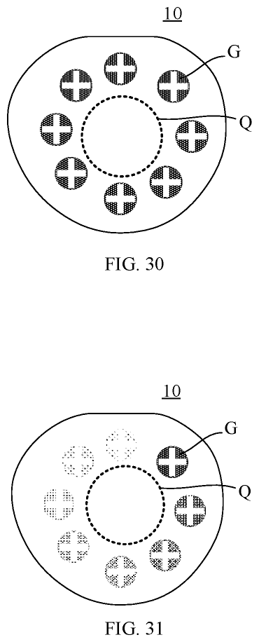

FIG. 30 is a schematic diagram of another eyewear provided by some embodiments of the present disclosure. FIG. 30 illustrates a display state of the display functional layer 10 in a therapeutic mode. In some embodiments, as shown in FIG. 30, the display functional layer 10 displays eight functional patterns G, and one functional pattern G corresponds to one pixel sub-region PQz (not shown in FIG. 30). The eight functional patterns G are shown with a same color. A central region Q of the myopia-correction structure 30 is also illustrated in FIG. 30, and it can be seen that the functional patterns G surround the central region Q. In the therapeutic mode, the display functional layer 10 displays multiple functional patterns G, and the functional patterns G can be used to image at multiple locations in the eye, realizing that multiple parts of the eye are stimulated at the same time.

In an embodiment, at least one of shape, color, brightness, or grayscale of a functional pattern G in one pixel sub-region PQz of at least two pixel sub-regions PQz differs from that of another functional pattern G in another pixel sub-region PQz of the at least two pixel sub-regions PQz in the therapeutic mode. Different functional patterns G are different from each other due to that they are different from in at least one of the four features of shape, color, brightness, and grayness. Two functional patterns G are different from each other in one feature, two features different, or multiple features. The eyewear provided by some embodiments of the present disclosure are capable of utilizing the display functional layer 10 to display diverse functional patterns G to achieve diverse therapeutic modes, which can prevent the eye from stimulation fatigue caused by a single pattern.

FIG. 31 is a schematic diagram of another eyewear provided by some embodiments of the present disclosure. FIG. 31 illustrates a display state of the display functional layer 10 in another therapeutic mode. In an embodiment, as shown in FIG. 31, the display functional layer 10 displays eight functional patterns G with eight different grayscales. The embodiments of FIG. 29 illustrate that the eight functional patterns G are different from each other only in only one feature, i.e., grayscale.

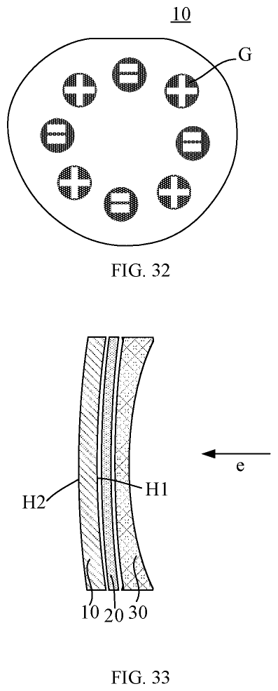

FIG. 32 is a schematic diagram of another eyewear provided by some embodiments of the present disclosure. FIG. 32 illustrates a display state of the display functional layer 10 in another therapeutic mode. In another embodiment, as shown in FIG. 32, the display functional layer 10 displays eight functional patterns G with different shapes. In another embodiment, the display functional layer 10 displays eight functional patterns G with eight different shapes.

In some embodiments, the therapeutic modes include a first mode and a second mode, and at least one of shape, color, brightness, or grayscale of the functional patterns G in at least one pixel sub-region PQz in the first mode differs from that of the functional patterns G in the at least one pixel sub-region PQz in the second mode. For example, one of FIG. 31 and FIG. 32 illustrates the first mode, and the other one of FIG. 31 and FIG. 32 illustrates the second mode. The number of therapeutic modes may not be limited to two. The operating mode of the eyewear can be set to automatically switch between multiple modes, or to select among multiple modes after receiving the user's operation instruction. The eyewear provided by some embodiments of the present disclosure can achieve diverse and multi-mode stimulation to the eye to avoid stimulation fatigue and also improve the user experience.

In some embodiments, the myopia-correction structure 30 has a central region Q. In one therapeutic mode, at least one of shape, color, brightness, or grayscale of the functional patterns G in the pixel sub-regions PQz that surround the central region Q changes gradually. In some embodiments, one of the four features of shape, color, brightness, and grayscale changes gradually. FIG. 31 illustrates that the grayscales of the functional patterns G displayed sequentially along the direction surrounding the central region Q change gradually. In other embodiments, each of two features of the four features of shape, color, brightness, and grayscale change gradually. For example, the grayscales of the functional patterns G displayed sequentially along the direction surrounding the central region Q change gradually, and shapes of these functional patterns G also change gradually. In this case, the gradually changed shapes means that the shapes gradually changes and adjacent functional patterns G have different shapes.

FIG. 33 is another cross-sectional view along line A-A′ shown in FIG. 3. In some embodiments, as shown in FIG. 33, a surface of the display functional layer 10 facing towards the light-guiding structure 20 is a first cambered surface H1, and a surface of the display functional layer 10 facing away from the light-guiding structure 20 is a second cambered surface H2, and the first cambered surface H1 matches the second cambered surface H2. For example, the first cambered surface H1 and the second cambered surface H2 are parallel or have a same curvature radius. Both the first cambered surface H1 and the second cambered surface H2 are recessed away from the light-guiding structure 20. In order to ensure that the light emitted from the pixel sub-region after the display functional layer 10 matches the light-guiding structure 20 can be imaged at a specific location in the eye, the distance between the display functional layer 10 and the eye can be reasonably set according to the conditions of the eye (such as the focal length of the crystalline lens in the eye, the length of the eye axis in the eye, etc.), and the relevant parameters of the light-guiding structure 20 (such as the focal length of the convex lens, etc.). The shape of the display functional layer 10 is designed to fit the shape of the eye in the embodiments of the present disclosure, and the display functional layer 10 is set to be curved, so that the distance between the pixel sub-regions of the display functional layer 10 and the eye are basically the same, and the imaging conditions for imaging the functional patterns displayed in all pixel sub-regions in the eye are basically the same, which simplifies the process of manufacturing the eyewear.

In some embodiments, the shape of the display functional layer 10 is the same as the shape of the myopia-correction structure 30, and the display functional layer 10, the light-guiding structure 20, and the myopia-correction structure 30 are elements of the lens of the eyewear.

In some embodiments, any two of the display functional layer 10, the light-guiding structure 20 and the myopia-correction structure 30 are bonded to each other by the optical adhesive.

In other embodiments, any adjacent two of the display functional layer 10, the light-guiding structure 20 and the myopia-correction structure 30 are attached to each other with a glue-free process.

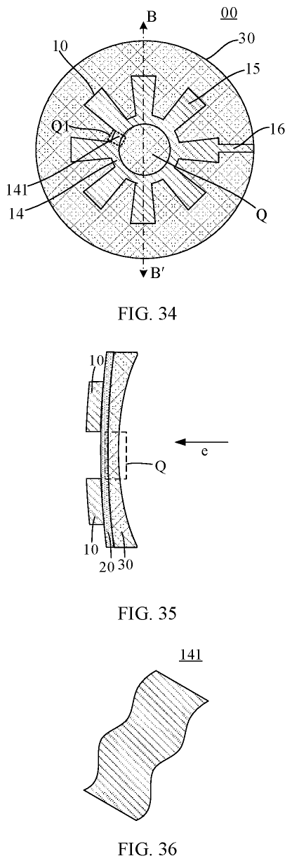

FIG. 34 is a schematic diagram of another eyewear provided by some embodiments of the present disclosure. FIG. 35 is another cross-sectional view along line B-B′ shown in FIG. 34. FIG. 34 is a top view of a lens 00 of the eyewear. In some embodiments, as shown in FIG. 34, the display functional layer 10 includes a first connection part 14 and at least one protrusion 15, the myopia-correction structure 30 has a central region Q, the first connection part 14 at least partially surrounds the central region Q, the protrusion 15 is connected to the first connection part 14, and the protrusion 15 protrudes away from the central region Q. In the user viewing direction e, the first connection part 14 is at least partially not overlapped with the central region Q. It can be seen from the top view that the shape of the display functional layer 10 is approximately same as a petal. Adjacent protrusions 15 are spaced apart from each other, and the adjacent protrusions 15 are connected to each other by the first connection part 14. With reference to FIG. 35, the display functional layer 10 is at least partially not overlapped with the central region Q. As shown in FIG. 35, the surface of the myopia-correction structure 30 facing towards the display functional layer 10 is a cambered surface, and taking the light-guiding structure 20 being located between the display functional layer 10 and the myopia-correction structure 30 as an example, the display functional layer 10 is attached to the cambered surface of the myopia-correction structure 30. In the embodiments of the present disclosure, the display functional layer 10 includes a first connection part 14 surrounding at least part of the central region Q, and a protrusion 15 projecting outwards from the first connection part 14, which can help the structures of the display functional layer 10 to deform to adapt to the shape of the cambered surface when the display functional layer 10 is attached to the cambered surface, prevent the display functional layer 10 from wrinkling, and ensure the attaching yield.

FIG. 34 illustrates that the first connection part 14 is a closed ring. In other embodiments, the first connection part 14 surrounds the central region Q to form a non-closed ring, which is not shown in figures herein.

In some embodiments, the display functional layer 10 includes light-emitting elements, the light-emitting elements disposed on the protrusions 15, respectively. The light-emitting elements are not shown in FIG. 34. It can be understood that the light-emitting elements on the protrusions 15 can define the pixel region PQ, so that a functional pattern G is displayed at the protrusion 15 in therapeutic mode. The pixel region PQ and the functional pattern G can be understood with reference to the relevant embodiments described above. In some embodiments, one protrusion 15 corresponds to one pixel sub-region PQz, and one protrusion 15 displays one functional pattern G in the therapeutic mode. Circuit wires are also provided on the protrusions 15 to drive the light-emitting elements within the pixel region PQ to emit light.

The ring design of the first connection part 14 can ensure the connection between all protrusions 15 in the display functional layer 10, and circuit wiring can be provided in the first connection part 14, and a signal can be provided into the protrusion 15 through the circuit wires to drive the light-emitting elements on the protrusions 15. The ring design of the first connection part 14 makes the first connection part 14 not overlap with the central region Q, which can ensure the light transmittance in the central region Q and the brightness of the imaged formed imaged in the eye by light passing through the central region Q. After wearing the eyewear, the user can see the front objects clearly through the central region Q.

In some embodiments, a shift driving circuit is provided on the protrusion 15 and includes a shift register, and the shift driving circuit is configured to drive the light-emitting element on the protrusion 15.

In other embodiments, no shift driving circuit is provided on the protrusion 15, the driver structure of the eyewear is electrically connected to the light-emitting element via a signal line, and the signal line provides a light-emitting signal directly to the light-emitting element to control the light-emitting element to emit light.

As shown in FIG. 34, the first connection part 14 includes a connection sub-part 141 connected between two adjacent protrusions 15. FIG. 36 is an enlarged schematic view of a region Q1 shown in FIG. 34. As shown in FIG. 36, an edge of the connection sub-part 141 is curved. The curved edge of the connection sub-part 141 increases the length of the edge of the connection sub-part 141 and helps to stretch and deform the connection sub-part 141. When attaching the display functional layer 10 to a structure having a cambered surface, the connection sub-part 141 can be deformed to attach to the cambered surface structure to prevent stretching and breaking, thereby preventing lines in the display functional layer 10 from breaking and improving the attaching yield.

As shown in FIG. 34, the display functional layer 10 also includes a second connection part 16, and the second connection part 16 includes one end connected to the first connection part 14 and another end extending to an edge of the lens 00.

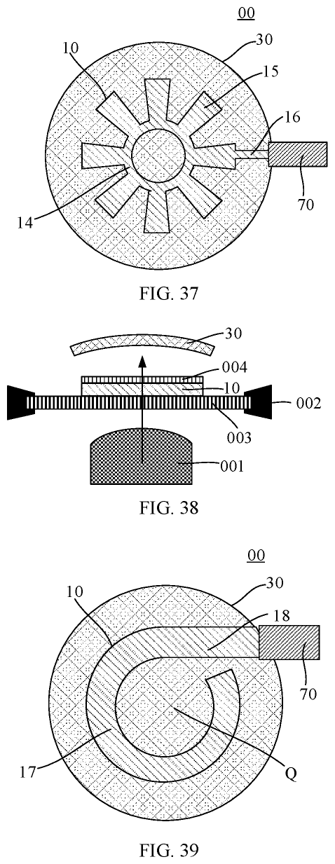

FIG. 37 is a schematic diagram of another eyewear provided by some embodiments of the present disclosure. In some embodiments, as shown in FIG. 37, the eyewear also includes a driver structure 70 configured to drive and control the display functional layer 10. The driver structure 70 may be a flexible circuit board, and the driver structure 70 includes a driving chip. The second connection part 16 includes a first end (not marked in FIG. 37) connected to an end of the protrusion 15 away from the first connection part 14, and a second end (not marked in FIG. 37) bound to the driver structure 70. In the embodiments, the second connection part 16 is extended to the edge of the lens 00 to bind the driver structure 70 to drive the display functional layer 10. The second connection part 16 occupies a small area of the lens and is able to prevent the display functional layer 10 from blocking light in front of the eyewear.

Embodiments of the present disclosure also provide a method for manufacturing eyewear. FIG. 38 is a schematic diagram of a method for manufacturing an eyewear provided by some embodiments of the present disclosure. As shown in FIG. 38, taking a surface of the display functional layer 10 facing towards the display functional layer 10 being the cambered surface as an example, when attaching the display functional layer 10 to the cambered surface of the myopia-correction structure 30, the attaching can be performed using a profiling fixture. A profiling platform 001 is provided; the flexible guiding film 003 is fixed using the fixing fixture 002, and a flexible guiding film 003 is provided on top of the profiling platform 001; the display functional layer 10 is placed on top of the flexible guiding film 003, and the adhesive layer 004 is formed on a side of the display functional layer 10 facing away from the flexible guiding film 003; and the display functional layer 10 is laminated and attached to the myopia-correction structure 30 using the platform 001, so that the display functional layer 10 is attached to the cambered surface of the myopia-correction structure 30 in a cambered shape.

The manufacturing method provided in the embodiments of FIG. 38 is illustrated only with the display functional layer 10 being attached to the myopia-correction structure 30 having a cambered surface. In some embodiments, the light-guiding structure 20 is located between the myopia-correction structure 30 and the display functional layer 10; and in the manufacturing process, the light-guiding structure 20 is attached to the myopia-correction structure 30, and then the display functional layer 10 is attached to the cambered surface of the light-guiding structure 20 facing away from the myopia-correction structure 30.

FIG. 39 is a schematic diagram of another eyewear provided by some embodiments of the present disclosure. In some embodiments, as shown in FIG. 39, the display functional layer 10 includes at least one annular part 17, the annular part 17 is a non-closed ring, and the annular part 17 partially surrounds the central region Q. The annular part 17 includes a pixel region, the pixel region includes at least one pixel sub-region, and light-emitting elements are provided in the pixel sub-region. In the embodiments, the display functional layer 10 includes the annular part 17 surrounding the central region Q, and the annular part 17 is a non-closed ring. When the surface to which the display functional layer 10 is attached is a cambered surface, the design of the annular part 17 can prevent the display functional layer 10 from wrinkling when it is attached to the cambered surface and ensure the attaching flatness. The design of the ring 17 surrounding the central region Q prevents the display functional layer 10 from blocking the light in the central region Q, and ensures the light transmittance in the central region Q to ensure the brightness of the image in the eyes formed by the light passing through the central region Q. After wearing the eyewear, the user can see front object clearly through the central region Q.

As shown in FIG. 39, the display functional layer also includes a third connection part 18, the ring part 17 is connected to a third end (not marked in FIG. 39) of the third connection part 18, and a fourth end (not marked in FIG. 39) of the third connection part 18 is bound to the driver structure 70. The third connection part 18 is extended to the edge of the lens 00 to bind the driver structure 70 to drive the display functional layer 10.

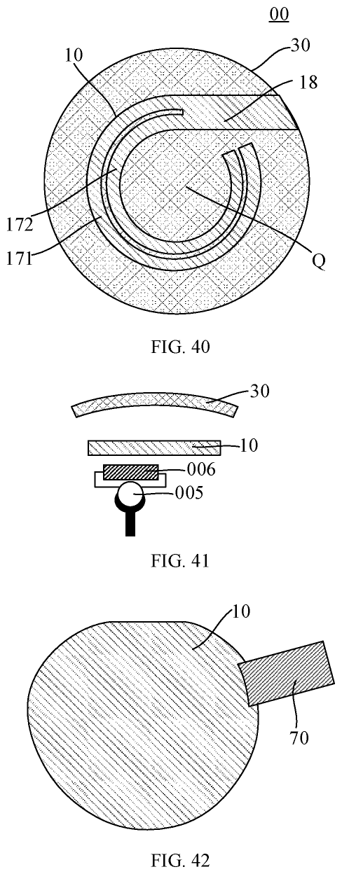

FIG. 40 is a schematic diagram of another eyewear provided by some embodiments of the present disclosure. In some embodiments, as shown in FIG. 40, the annular part 17 includes a first annular sub-part 171 and a second annular sub-part 172, the first annular sub-part 171 partially surrounds the central region Q, the second annular sub-part 171 partially surrounds the first annular sub-part 172, and both the first annular sub-part 171 and the second annular sub-part 172 are connected to the third connection part 18.

In other embodiments, the display functional layer 10 may also include three or more annular sub-parts, and all annular sub-parts surround the central region Q, which is not shown in the figures herein.

Embodiments of the present disclosure also provide another manufacturing method used to manufacture the eyewear provided in the embodiments of FIG. 39. FIG. 41 is a schematic diagram of another method for manufacturing an eyewear provided by some embodiments of the present disclosure. As shown in FIG. 41, taking the surfacing of the myopia-correction structure 30 facing towards the display functional layer 10 being a cambered surface as an example, when attaching the display functional layer 10 to the cambered surface of the myopia-correction structure 30, a roller 006 can be driven by a universal shaft 005 to roll in order to attach the strip-shaped display functional layer 10 to the cambered surface, and finally the annular part 17 surrounding the central region Q is formed. The manufacturing method provided by the embodiments can prevent the display functional layer 10 from wrinkling when being attached to the cambered surface, and can ensure the attaching flatness.

In some embodiments of the present disclosure, the display functional layer 10 is planar, and the shape of the display functional layer 10 is substantially the same as the shape of the eyewear lens.

In some other embodiments of the present disclosure, the display functional layer 10 is in an irregular shape, such as the petal shape illustrated in the embodiments of FIG. 34, or the ring shape illustrated in FIG. 39.

In some embodiments, the eyewear lens has an arc edge, and in order to drive the display functional layer 10, the end of the display functional layer 10 is extended to the arc edge of the lens and then bound to the driver structure 70. The arrangement of pads at the binding position where the display functional layer 10 is bound to the driver structure 70 is designed in some embodiments of the present disclosure.

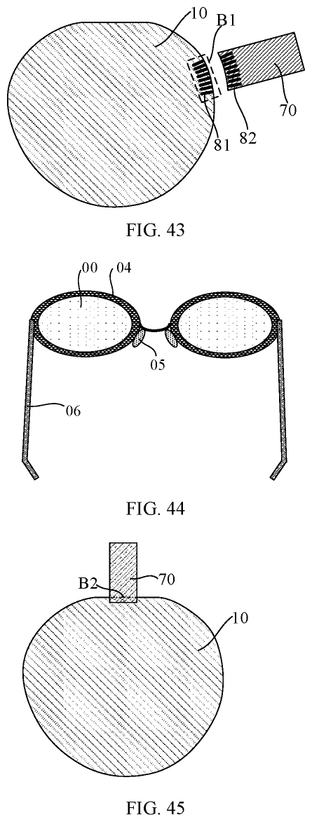

FIG. 42 is a schematic diagram of another eyewear provided by some embodiments of the present disclosure. FIG. 43 is a schematic diagram of disassembly of an eyewear shown in FIG. 42. As shown in FIG. 42, the display functional layer 10 and the driver structure 70 are bound and connected to each other. The shape of the display functional layer 10 is only schematically illustrated. FIG. 43 is an exploded diagram of a position where the display functional layer 10 is bound to the driver structure 70. As shown in FIG. 43, the display functional layer 10 includes a first end B1, and the first end B1 has an arc edge; the first end B1 includes first pads 81, and multiple first pads 81 are adapted to the shape of the arc edge of the first end B1; the driver structure 70 includes second pads 82, and multiple second pads 82 are adapted to the shape arrangement of the arc edge of the first end B1; and the second pad 82 is bound to the first pad 81. In the embodiments, at the position where the display functional layer 10 and the driver structure 70 are bound to each other, the arrangement of the pads of the display functional layer 10 and the arrangement of the pads of the driver structure 70 are both designed using the shape of the arc edge, which can reduce the area occupied by the bound position on the lens and improve the aesthetics of the eyewear.

FIG. 44 is a schematic diagram of another eyewear provided by some embodiments of the present disclosure. In some embodiments, as shown in FIG. 44, the eyewear includes an eyewear lens 00, an eyewear frame 04, a nose pad 05, and an eyewear leg 06. The eyewear frame 04 is used to hold the lens 00, and FIG. 44 illustrates that the eyewear frame 04 surrounds the eyewear lens 00 to completely wrapping the eyewear lens 00, that is, the eyewear frame 04 is a full-frame. In other embodiments, the eyewear frame 04 is a half-frame, and the eyewear frame 04 surround only a part of the outer edge of the eyewear lens 00. The eyewear lens 11 includes a display functional layer 10, a light-guiding structure 20, and a myopia-correction structure 30. In one embodiment, the driver structure 70 has an end bound to the display functional layer 10 and another end extending into the nose pad 05. In another embodiment, the driver structure 70 has one end bound to the display functional layer 10 and another end extending into the eyewear leg 06. In the embodiments, the driver structure 70 is hidden inside the eyewear leg 06 or the nose pad 05 to reasonably utilize the space of the eyewear structure and improve the overall aesthetics.

FIG. 45 is a schematic diagram of another eyewear provided by some embodiments of the present disclosure. In some embodiments, FIG. 45 illustrates a position where the display functional layer 10 and the driver structure 70 are bound together. As shown in FIG. 45, the display functional layer 10 includes a second end B2, the second end B2 has a linear edge, and the driver structure 70 is bound to the second end B2.

FIG. 46 is a schematic diagram of another eyewear provided by some embodiments of the present disclosure. As shown in FIG. 46, the eyewear frame 04 includes a straight border ZB, and the linear edge of the second end B2 of the display functional layer 10 is adjacent to the straight border ZB. The position of the second end B2 of the display functional layer 10 can be understood in conjunction with FIG. 45. In this case, one end of the driver structure 70 is bound to the second end B2, and another end of the driver structure 70 extends into the straight border ZB. The region Q3 in FIG. 46 is the region where the display functional layer 10 and the driver structure 70 are bound together. In the embodiments of the disclosure, the driver structure 70 is hidden inside the straight border ZB to reasonably utilize the space of the eyewear structure and improve the overall aesthetics.

FIG. 47 is a schematic diagram of another eyewear provided by some embodiments of the present disclosure. In some other embodiments, as shown in FIG. 47, the display functional layer 10 includes a first surface m1, a second surface m2, and a side surface m3, the first surface m1 is a surface of the display functional layer 10 facing towards the light-guiding structure 20, the second surface m2 is a surface of the display functional layer 10 facing away from the light-guiding structure 20, and the side surface m3 connects the first surface m1 with the second surface m2. The driver structure 70 is bound to the side surface m3. As shown in FIG. 48, the side surface m3 includes first pads 81, the driver structure 70 includes second pads 82, and first pads 81 are bound to second pads 82. In this embodiment, the signal lines in the display functional layer 10 are connected to the first pads 81 located on the side surface m3, and the driver structure 70 is bound on the side surface m3 by the first pads 81, so that the driver structure 70 is not exposed inside the lens surface and the overall aesthetics of the eyewear can be improved.

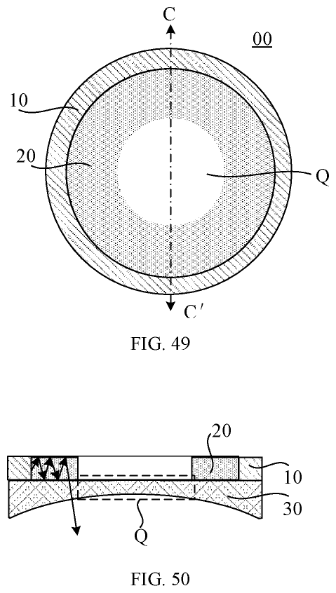

Some embodiments of the present disclosure also provide another eyewear in which the display functional layer 10 in the eyewear surrounds the light-guiding structure 20. FIG. 49 is a schematic diagram of another eyewear provided by some embodiments of the present disclosure. FIG. 50 is a cross-sectional view along line C-C′ shown in FIG. 49. FIG. 49 is a top view of a lens 00. As shown in FIG. 49, the display functional layer 10 surrounds the light-guiding structure 20. The display functional layer 10 is a display panel and includes light-emitting elements (not shown in FIG. 49), and the light-emitting elements are organic light-emitting diodes or inorganic light-emitting diodes. The light-emitting elements surround the light-guiding structure 20. The light-guiding structure 20 includes a volume grating. It can be seen from FIG. 50 that the myopia-correction structure and the light-guiding structure 20 are substantially stacked together. The volume grating is a spatial grating, and the refractive index alternates along a direction inside the volume grating. FIG. 50 illustrates a light path of light emitted from the display functional layer 10 to the light-guiding structure 20. As shown in FIG. 50, the light emitted from the display functional layer 10 is incident to the interior of the volume grating from the side surface of the volume grating, and then refracted several times inside the volume grating and then emitted towards the myopia-correction structure 30. When wearing the eyewear, the light emitted after the action of the volume grating is emitted towards the eye and finally enters the eye to form an image. The refractive index of the volume grating is designed to control the optical path of the light entering the eye from the volume grating, which ultimately allows the light to be imaged at a specific position in the eye. By designing the refractive index of the interior of the volume grating, an image with a specific pattern (such as the shape of the functional pattern designed in the above embodiments) can be formed in the eye after the action of the volume grating. The principle of forming the image in the eye by light is the same as the principles illustrated in above FIG. 5 and FIG. 6, and will not be repeated herein.

With the operation between the display functional layer 10 and the light-guiding structure 20, the position where light is imaged in the eye can be adjusted. The imaging position can be located on the retina, in front of the retina, or behind the retina. When controlling the imaging position to be out of the retina, a defocus state is formed, and the defocus state causes a blurred pattern to be visible by the user. The defocus state stimulates the growth of the eye and controls the change in the length of the eye axis to prevent and control the increase in vision diopter. In the embodiments, the display functional layer 10 and the light-guiding structure 20 cooperate with each other to achieve an active defocus adjustment, which can be applied to multiple mode, increasing user's participation, and satisfying users' personal needs.

In some embodiments, in conjunction with FIG. 49 and FIG. 50, the volume grating in the light-guiding structure 20 at least partially surrounds the central region Q of the myopia-correction structure 30. That is, no volume grating is provided at the position corresponding to the central region Q. In other words, the volume grating has a hollow region corresponding to the central region Q. In this way, it can be avoided that the volume grating interferes the light from the central region Q. After wearing the eyewear provided in the embodiment of the present disclosure, the user sees objects at the central vision through the central region Q of the myopia-correction structure 30.

In some other embodiments, the volume grating in the light-guiding structure 20 is planer. That is, the volume grating includes no hollow at the position corresponding to the central region Q, which will not be illustrated in the figures herein.

The above are merely exemplary embodiments of the present disclosure and are not intended to limit the present disclosure. Any modifications, equivalents, improvements, etc., which are made within the principles of the present disclosure, should fall into the scope of the present disclosure.

Finally, it should be noted that the above embodiments are only used to illustrate, rather to limit, the technical solution of the present disclosure. Although the present disclosure is described in details with reference to the above embodiments, it should be understood by those skilled in the art that they can still modify the technical solution recorded in the above embodiments, or to make equivalent replacement to some or all of the technical features thereof; and these modifications or replacements do not make the essence of the corresponding technical solution deviate from the scope of the technical solutions of all embodiments of the present disclosure.

What is claimed is:

1. An eyewear, comprising:
a display functional layer; and
a light-guiding structure, wherein the light-guiding structure is located at a side of the display functional layer facing towards a viewing surface, or wherein the display functional layer surrounds the light-guiding structure.

2. The eyewear according to claim 1, further comprising:
a myopia-correction structure located at the side of the display functional layer facing towards the viewing surface.

3. The eyewear according to claim 2, wherein the myopia-correction structure and the light-guiding structure are formed into one piece.

4. The eyewear according to claim 2, wherein the light-guiding structure and the myopia-correction structure form an optical structure, and a media layer is configured between the optical structure and the display functional layer.

5. The eyewear according to claim 4, wherein a surface of the media layer and a surface of the optical structure are cambered surfaces that are in contact with each other.

6. The eyewear according to claim 1, wherein the display functional layer has a pixel region where light-emitting elements are provided, wherein the light-guiding structure and the pixel region at least partially overlap.

7. The eyewear according to claim 6, wherein the light-guiding structure comprises light-guiding groups, wherein each light-guiding group comprises microstructures, and wherein a distance between two adjacent light-guiding groups is greater than a distance between two microstructures within each (?) light-guiding group.

8. The eyewear according to claim 7, wherein the pixel region comprises pixel sub-regions, wherein the pixel sub-regions comprise a first pixel sub-region and a second pixel sub-region, wherein a distance between the first pixel sub-region and the second pixel sub-region is greater than a distance between two light-emitting elements within the pixel sub-region; and
wherein the light-guiding groups comprise a first light-guiding group and a second light-guiding group, wherein the first light-guiding group overlaps with the first pixel sub-region, and the second light-guiding group overlaps with the second pixel sub-region.

9. The eyewear according to claim 1, further comprising:
a myopia-correction structure, wherein the myopia-correction structure has a central region, and the light-guiding structure at least partially surrounds the central region.

10. The eyewear according to claim 1, further comprising:
a myopia-correction structure, wherein the myopia-correction structure has a central region, the display functional layer has a pixel region, and the pixel region at least partially surrounds the central region.

11. The eyewear according to claim 1, wherein the display functional layer comprises light-emitting elements, the light-guiding structure comprises microstructures, and one microstructure corresponds to at least two light-emitting elements.

12. The eyewear according to claim 1, wherein the light-guiding structure comprises microstructures, wherein the microstructures are convex lenses.

13. The eyewear according to claim 12, further comprising:
a myopia-correction structure, wherein the myopia-correction structure has a first surface facing towards the light-guiding structure, wherein the first surface is a cambered surface and has a geometric center; and
wherein the convex lenses comprise a first convex lens and a second convex lens, wherein a distance between the first convex lens and the geometric center is different from a distance between the second convex lens and the geometric center, and the first convex lens and the second convex lens have different focal lengths.

14. The eyewear according to claim 1, wherein the display functional layer has a pixel region comprising pixel sub-regions; and
wherein the eyewear has a therapeutic mode, in which at least one pixel sub-region within the display functional layer emits light configured to show a functional pattern.

15. The eyewear according to claim 14, wherein the display functional layer has a redundant region, wherein the redundant region is located between adjacent sub-pixel regions; and
wherein no image is displayed in the redundant region in the therapeutic mode.

16. The eyewear according to claim 14, wherein the at least one pixel sub-region comprises a graphic region and a peripheral region, wherein the graphic region and the functional pattern have a same shape; and
wherein one of the graphic region and the peripheral region emits light, and other one of the graphic region and the peripheral region does not emit light to show the functional pattern.

17. The eyewear according to claim 14, wherein the at least one pixel sub-region comprises the functional pattern having gradually changing colors or gradually changing brightness.

18. The eyewear according to claim 14, wherein the at least one pixel sub-region comprises a graphic region and a peripheral region, wherein the graphic region and the functional pattern have a same shape; and
wherein luminous brightness of the graphic region is different from luminous brightness of the peripheral region to show the functional pattern.

19. The eyewear according to claim 14, wherein the at least one pixel sub-region emits light with a single color to show the functional pattern.

20. The eyewear according to claim 14, wherein functional patterns of at least two pixel sub-regions are different from each other in at least one of shape, color, luminance, or grayscale.

21. The eyewear according to claim 14, wherein the therapeutic mode comprises a first mode and a second mode, wherein the functional pattern in the first mode and the functional pattern in the second mode are different from each other in at least one of shape, color, luminance, or grayscale.

22. The eyewear according to claim 14, further comprising:
a myopia-correction structure having a central region,
wherein functional patterns in the pixel sub-regions are sequentially arranged in a direction surrounding the central region have a gradual change in at least one of shape, color, brightness, and gray scale.

23. The eyewear according to claim 1, wherein the display functional layer comprises a light-emitting element, wherein the light-emitting element is a light-emitting diode.

24. The eyewear according to claim 1, wherein the display functional layer is a transparent display panel.

25. The eyewear according to claim 1, wherein the display functional layer has a first cambered surface facing towards the light-guiding structure, and a second cambered surface facing away from a side of the light-guiding structure, wherein the first cambered surface matches the second cambered surface.

26. The eyewear according to claim 1, further comprising:
a myopia-correction structure having a central region,
wherein the display functional layer comprises a first connection part at least partially surrounding the central region, and at least one protrusion connected to the first connection part and protruding away from the central region.

27. The eyewear according to claim 26, wherein the display functional layer comprises light-emitting elements arranged on the protrusions.

28. The eyewear according to claim 26, wherein the first connection part comprises a connection sub-part connected between two adjacent protrusions, wherein the connection sub-part has a curved edge.

29. The eyewear according to claim 28, further comprising:
a driver structure,
wherein the display functional layer further comprises a second connection part, wherein the second connection part has a first end connected to an end of the protrusion away from the first connection part, and a second end bound to the driver structure.

30. The eyewear according to claim 1, further comprising:
a myopia-correction structure having a central region,
wherein the display functional layer comprises at least one annular part, wherein the annular part is a non-closed ring and partially surrounds the central region.

31. The eyewear according to claim 30, further comprising:
a driver structure,
wherein the display functional layer further comprises a third connection part, wherein the third connection part comprises a third end connected to the annular part, and a fourth end bound to the driver structure.

32. The eyewear according to claim 1, further comprising:
a driver structure,
wherein the display functional layer comprises a first end having a curved edge and comprising first pads, wherein the first pads are arranged in a shape of the curved edge of the first end; and
the driver structure comprises second pads, wherein the second pads are arranged in the shape of the curved edges of the first end and are bound to the first pads.

33. The eyewear according to claim 1, further comprising:
a driver structure; and
one of a nose pad and an eyewear leg, wherein the driver structure has one end bound to the display functional layer, and another end extending into the nose pad or the eyewear leg.

34. The eyewear according to claim 1, further comprising:
an eyewear frame comprising a straight border; and
a driver structure,
wherein the display functional layer comprises a second end having a straight edge, the straight edge is adjacent to the straight border; and the driver structure has one end bound to the second end and another end extending into the straight border.

35. The eyewear according to claim 1, further comprising:
a driver structure, wherein the display functional layer comprises a first surface facing towards the light-guiding structure, a second surface facing away from the light-guiding structure, and a side surface connecting the first surface with the second surface,
wherein first pads are provided on the side surface, the driver structure comprises second pads, and the first pads are bound to the second pads.

36. The eyewear according to claim 1, wherein the display functional layer comprises light-emitting elements, wherein the light-emitting elements are arranged along a direction surrounding the light-guiding structure, and the light-guiding structure comprises a volume grating.

37. The eyewear according to claim 36, further comprising:
a myopia-correction structure having a central region, wherein the volume grating at least partially surrounds the central region.
